(19) United States
(12) Patent Application Publication
(10) Pub. No.: US 2010/0235253 A1
(43) Pub. Date: Sep. 16, 2010

(54) Secured Item Delivery Method and Device

(76) Inventor: Moshe Pinkas, Brooklyn, NY (US)

Correspondence Address: Law Office of Michael J. Feigin, 103 The Circle, (http://PatentLawNY.com), Passaic, NJ, 07055, US

(21) Appl. No.: 12/402,084

(22) Filed: Mar. 11, 2009

(51) Int. Cl. G06Q 30/00; G06F 21/00; H04B 7/00

(52) U.S. Cl. 705/26; 726/21; 455/41.2

(57) ABSTRACT

The technology is of methods, devices, and systems for conducting transactions. Orders may be placed via public data networks where a device indicator or other unique identifier of the purchasing device is transmitted to the merchant. The order is then delivered by the merchant to a location indicated in the order or associated with the purchaser or purchaser's device, or alternatively, the order is picked up by the purchaser. The purchaser then transits or exhibits directly from the device used to make the purchase to a device associated with, or operated by, the merchant, the device indicator, or other unique identifier to verify and identify the transaction and ensure security of a transaction. Embodiments of the disclosed technology may be used at sporting events or other large venues as part of online or catalog shopping and deliveries.

### FIELD OF THE DISCLOSED TECHNOLOGY

The disclosed technology relates generally to delivery of goods or services and, more specifically, to methods and devices for ensuring such delivery is to the proper recipient.

### BACKGROUND OF THE DISCLOSED TECHNOLOGY

Online ordering and its predecessor, catalog shopping, are, of course, known in the art. Since the famous Sears Roebuck catalogs of the 1800s through today, the process has sometimes changed mediums, but the method remains more or less unchanged. A purchaser selects a product to buy, notifies the merchant by mail or electronic means, such as the internet or a computer network, forwards payment information, and the merchant sends the desired product.

Fraud has been an ongoing concern with such ordering methods. A person with a fake credit card number can similarly order such a product. Still further, products may be shipped to a different address, such as to an abandoned dwelling place. While requiring the shipping address to be the same as the billing address may cut down on some fraudulent purchases, this also limits the versatility of online orders. Still further, in settings such as at a public event, the “shipping address,” that is, an individual seat, is away from the purchaser's home. While in such instances, the seat location may be used, it is entirely possible for a person other than the purchaser to actually be in the seat through deception or through a purchaser error. Amongst or more stadium attendees placing orders, and some attempting to go to a concession stand to pick up their orders where such services are available, mistakes can be made.

Even in a transaction which takes place in person from beginning to end, problems of fraud and mistakes may still occur. For example, an order may be given to an incorrect purchaser, such as when many patrons are waiting on a line and ordering a product such as food, which takes preparation time, or where a first person places an order and a second person claims the order as his own.

Needed are a system and method for enabling the ordering of products and services while allowing for versatility of ordering and drop-off locations. A further requirement is reduction of fraud in transactions.

### SUMMARY OF THE DISCLOSED TECHNOLOGY

It is therefore an object of the disclosed technology to provide more secure transactions.

It is a further object of the disclosed technology to provide simple methods and devices for carrying out such secure transactions.

In an embodiment of the disclosed technology, an order for goods or services is delivered based on receiving data via a public data network from a handheld wireless device, the data comprising an order for an item and at least part of a unique identifier. At a later time, data comprising at least part of the unique identifier is received directly from the handheld wireless device. After verifying authenticity of the unique identifier, the order is furnished to the purchaser.

The order may be delivered (brought) to a location of the handheld wireless device before the step of receiving the unique identifier directly. The steps of receiving directly and furnishing may instead be substantially at a location where the order is prepared (e.g., the merchant's store or venue). Receiving directly may involve receiving directly to a handheld wireless device associated with a merchant furnishing the order. The unique identifier may be a substantially unchangeable identifier of the handheld wireless device and may further comprise an order identification number.

In another embodiment of the disclosed technology, an order for goods or services is placed by instructing a handheld wireless device to send an order for an item to a merchant via a public data network. A unique identifier is further transmitted. Then, data is exhibited directly to the merchant, the data having the unique identifier as part or all of the data. After the merchant verifies authenticity of the unique identifier, the goods or services can be received.

The exhibiting may be by way of displaying the unique identifier on the handheld device or a transfer of data via a short range wireless communication method. The instructing to order goods and receiving of the goods (or services) may occur at substantially one location, such as a seat within a venue. The exhibiting may be directly to a handheld wireless device associated with a merchant furnishing the order, such as a delivery tracking device as is generally known in the art of delivery, or a specialized device developed to carry out embodiments of the disclosed technology.

A device for processing an order is also part of embodiments of the disclosed technology. Display means, such as liquid crystal and cathode ray displays and other monitors and screens generally known in the art for displaying an order received over a data network, may be used to display an order or a unique identifier of a handheld wireless device sending the order. Input means, such as a network controller, infrared sensor, barcode reader, or the like for receiving an input exhibited by the handheld wireless device may be used. Verification means for verifying that the input comprises the unique identifier, and notification means for notifying when an order may be furnished based on or after the verification, are also claimed.

### BRIEF DESCRIPTION OF THE DRAWINGS

FIG. 1 shows a high level block diagram of devices on which embodiments of the disclosed technology may be carried out utilizing a merchant order device and merchant delivery device.

FIG. 2 shows a high level block diagram of devices on which embodiments of the disclosed technology may be carried out utilizing a merchant processing device.

FIG. 3 shows a purchaser method of carrying out embodiments of the disclosed technology at a venue.

FIG. 4 shows methods of ordering tickets utilizing devices of the disclosed technology.

FIG. 5 shows a method of an embodiment of the disclosed technology where funds transfer takes place after direct exhibiting of the unique identifier.

FIG. 6 shows the steps taken by a merchant in embodiments of the disclosed technology.

FIG. 7 shows a high level block diagram of a device on which embodiments of the disclosed technology may be carried out.

FIG. 8 shows a high-level block diagram of a computer that may be used to carry out the disclosed technology.

### DETAILED DESCRIPTION OF EMBODIMENTS OF THE DISCLOSED TECHNOLOGY

Embodiments of the disclosed technology are new methods, devices, and systems for conducting transactions. Orders may be placed via electronic data networks where a device indicator or other unique identifier of the purchaser or the purchase is also transmitted to the merchant. A device indicator is a unique identifier associated with the device used to carry out the purchase. The order is then delivered by the merchant to a location indicated in the order or associated with the purchaser or purchaser's device, or alternatively, the order is picked up by the purchaser. In either case, the purchaser then transmits or exhibits directly from the device used to make the purchase to a device associated with or operated by the merchant, the device indicator, or other unique identifier, in order to verify identity and ensure that the order is delivered to the person or entity that placed the order.

Embodiments of the disclosed technology will become clearer in connection with a description of the figures.

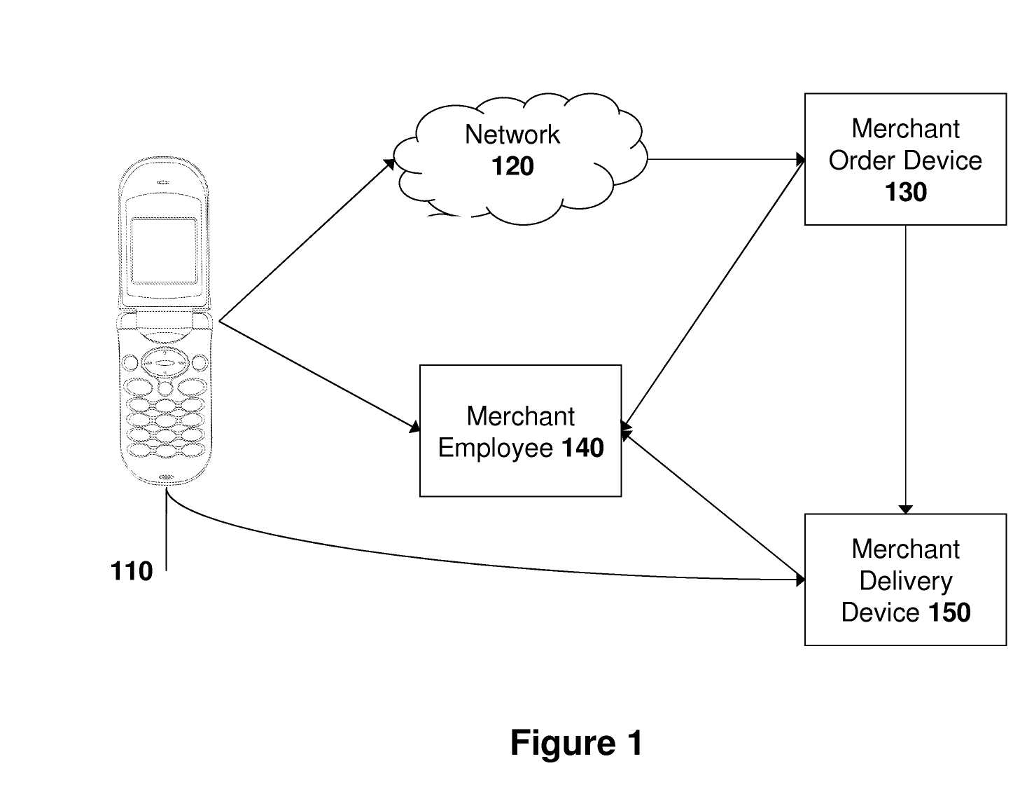

FIG. 1 shows a high level block diagram of devices on which embodiments of the disclosed technology may be carried out, utilizing a merchant order device and merchant delivery device. Purchasing device 110 is a device used in embodiments of the disclosed technology to place an order for an item or service. As shown in FIG. 1, purchasing device 110 is a cellular phone; however, the device may be any handheld wireless device with network connectivity to the internet or a wireless network on which the merchant is also connected, such as a local wireless network in a store or restaurant. Such networks, accessible by substantially any patron of a merchant's establishment, whether a store, stadium, or the like, as well as networks such as are commonly known as being part of the internet, are deemed public networks for purposes of this disclosure. The purchasing device 110, in embodiments of the disclosed technology, comprises a substantially unchangeable device indicator, such as a pre-programmed MAC (media access control) address in a component of the device, a hard-coded (i.e., unchangeable with software) identifier or the like. Such a device indicator may partially or wholly make up the unique identifier. An order number or data related to the specific order may be combined with the device indicator or, instead, be used as part or all of the unique identifier.

Purchasing device 110 communicates an order via network 120 to a merchant ordering device 130. The network 120 may be the internet or a segment thereof. The network 120 may also be an internal network, such as a wireless network or local area network used within a store or venue. Network 120 may be any packet switched or internet protocol network, by way of example. The merchant ordering device 130, in embodiments of the disclosed technology, is a computer system, such as an order system for receiving and displaying incoming orders on a display for an employee of the merchant to view, and prepare or arrange orders for products or services.

A merchant employee 140 or plurality of employees (hereinafter, “merchant”) carry out the functions of preparing an order and delivering the order, whether at the location of the merchant (e.g., in or at a physical location where the order is received), the location of the purchaser (e.g., at or near the location of the purchasing device 110 at the time the order is made), or another designated location (e.g., designated at the time of the order by the merchant or purchaser). The merchant 140 operates a merchant delivery device 150 which is provided with the unique identifier via a data connection with the merchant order device 130. The merchant delivery device 150 further receives data from the purchasing device 110 directly (that is, without the use of a publicly accessible network and/or without a third party operated network device), such as via a direct data connection, line of sight data reading, or the like. Thus, the merchant delivery device 150 receives the unique identifier from the merchant order device 130 (via a network) and from the purchasing device 110 (directly), the latter, for example, just before giving the order to the purchaser. The delivery device 150 verifies that the unique identifier is correct, that is, it is the identifier associated with the person (or device) that placed the order. In this manner, it is determined whether the order is being delivered to the proper entity and thus decreases fraud.

Purchasing device 110, in embodiments of the disclosed technology, exhibits the unique identifier in one of a variety of methods. Such methods include transmitting the unique identifier via short range wireless communication directly (without a network intermediary) to the merchant. The unique identifier may be displayed on the device, such as on a screen of the device, or etched into the device itself. Such displays may be in the form of bar codes or alphanumeric displays. A device of the merchant 140 may read the data or receive the data electronically to determine that the unique identifier matches. As will be described below, such a method is applicable at sporting venues, at restaurants and concession stands, for home delivery of products ordered online, and other applications.

The merchant delivery device 150, in embodiments of the disclosed technology, is a handheld device and may be wired or wireless. The device 150 may be a bar code reader for reading a bar code etched on the purchasing device 110 or displayed on a screen of the purchasing device. The device may, in embodiments of the disclosed technology, receive data such as via short range wireless (e.g., infrared, near field communication, etc.) or wired communication from the purchasing device comprising the unique code. A merchant, for example, may deliver the order to a purchaser at a location designated by the purchaser or merchant (e.g., a drop-off point designated in the order, such as a home, a business, a seat at a venue, or a goods pickup location, such as a certain ticket booth or vendor location). The merchant delivery device 150 then reads the exhibited data from the purchasing device 110 to verify that the order is being delivered to the correct person, place, or entity, and the merchant 140 then delivers the goods or services which were ordered.

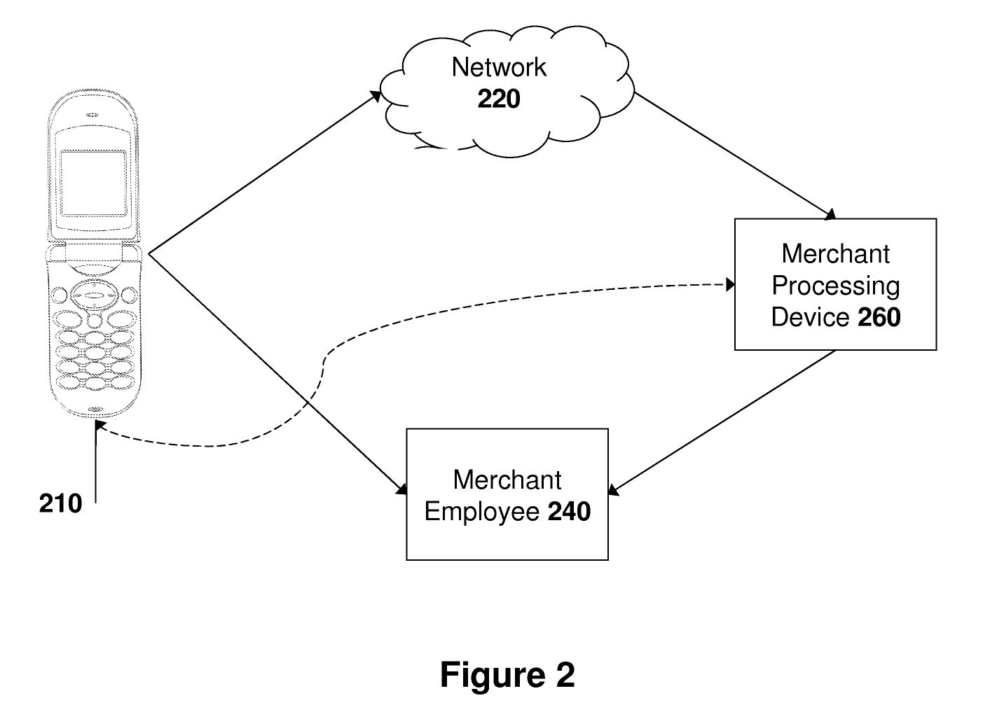

FIG. 2 shows a high level block diagram of devices on which embodiments of the disclosed technology may be carried out, utilizing a merchant processing device. While the embodiment of FIG. 1 allows for a separate order receiving device and delivery device which may be used when the order is being delivered to a location other than where the order is received, the embodiment of FIG. 2 may be used where the order is being delivered to the purchaser at the place of preparing or receiving the order. It should be understood that, while each embodiment may be more conducive to certain settings at certain times, each embodiment may be used in either setting described above.

Elements shown in FIG. 1 have been incremented by 100 in FIG. 2. The functions of the merchant order and merchant delivery devices are carried out by the merchant processing device 260. The merchant processing device may be any electronic device capable of receiving, sending, and processing data. The purchasing device 210 is used to place an order via network 220, which sends the order with a unique identifier to the merchant processing device 260. The merchant processing device displays or otherwise exhibits the order to a merchant 240 who prepares the order. The merchant 240 may use the merchant processing device 260 to send data back to the purchasing device 210, notifying the purchaser that the order is ready. When the merchant 240 delivers the contents of the order to the purchaser, or before doing so, the merchant receives an exhibited version of the unique identifier directly from the purchasing device 210 in any of the manners described above with respect to FIG. 1.

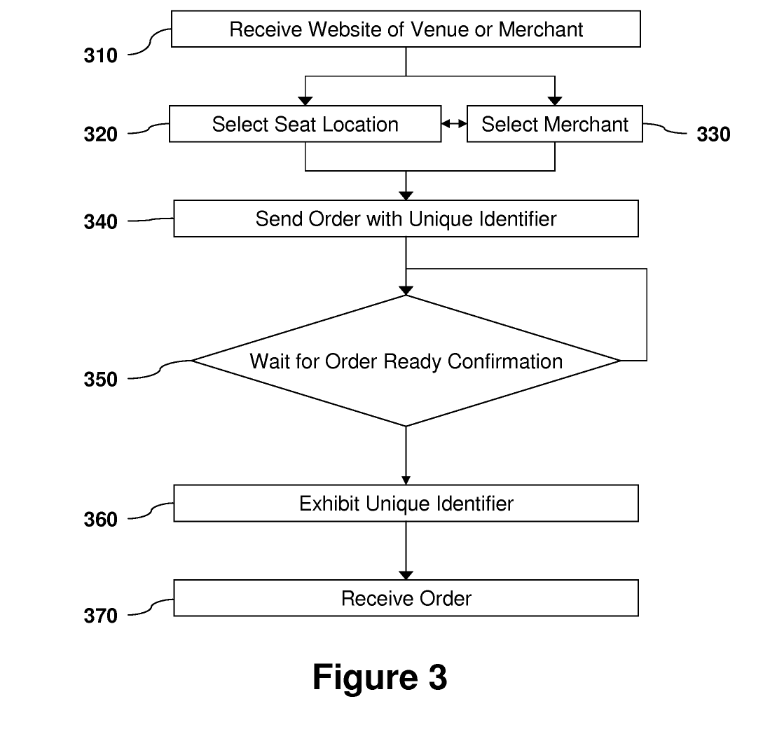

FIG. 3 shows a purchaser method of carrying out embodiments of the disclosed technology at a venue. The venue may, for example, be a sporting event, a concert, a show, or the like. The methods of the disclosed technology may be carried out on the devices described in FIG. 1 and FIG. 2, or other devices presented herein below.

In step 310, a website of the venue or the merchant is received, for example, on purchasing device 110. The website, as used in this disclosure, may be any data representative of products or services offered for sale by a merchant, which may be or are received at a device of a purchaser. One method of ordering is shown in FIG. 3. A seat location, in step 320, and/or a merchant, in step 330, is/are selected. Thus, for example, a purchaser may use his purchasing device 110 to point out that he is in seat 24E and wishes to order products from the visiting team's apparel provider. The seat location may be provided, already known, or simply not applicable where a purchaser must pick up his or her order from the merchant or at a location disclosed by the merchant before, during, or after the ordering process. In step 340, the order with a unique identifier, as described with reference to FIG. 1, is sent. The unique identifier may alternatively be generated by the merchant during the order process and sent to the purchaser's device 110.

Alternatively, step 310 (through step 330) may be carried out by sending the order with a unique identifier such as by sending a text message to a destination associated with or handling orders (such as using order device 130) on behalf of a venue or merchant. This may be accomplished by, for example, advertising during the performance at the venue, “using the device provided to you, enter code 973 to have one of our attendants bring to you a soda which will be charged to your account.”

In step 350, which is carried out in some embodiments of the disclosed technology, the purchaser then waits to receive data on the purchasing device 110 that the order is ready for pickup or that the order is now being delivered. Depending on the embodiment, the order may be picked up at the merchant's location (e.g., storefront or booth), delivered to the location of the purchaser (e.g., seat), or picked up at a location designated during the ordering process.

In step 360, the unique identifier is then exhibited by way of any of the methods described above and is received by the merchant or proxy for the merchant. The proxy for the merchant may also be an automated device. In the case of a venue, for example, a waiter may deliver the product to a seat location of the purchaser, or the purchaser may pick up the order at, for instance, a kiosk in his section of a stadium. The kiosk may be staffed by an attendant, or it may simply be a place to exhibit the unique identifier whereby the order is produced, as will be described below.

At some time before the receipt of the ordered goods or services, the merchant or proxy for the merchant receives the exhibited unique identifier directly from the purchasing device 110. At a venue where a waiter delivers the order to a seat of the purchaser, for example, the purchaser may send via near field communication, via infrared light, or display a bar code or alphanumeric code which is then read by the merchant delivery device 150 and/or the merchant to verify that the person claiming to have ordered the goods or services is the correct person. In embodiments of the disclosed technology, a bar code or the like may be printed on a sheet of paper by a device of the purchaser and displayed to the merchant.

After the unique identifier has been exhibited to the merchant or to the merchant delivery device, which then verifies proper receipt of the order (and/or may indicate which order should be delivered to the purchaser), in step 370 the order is received by the purchaser.

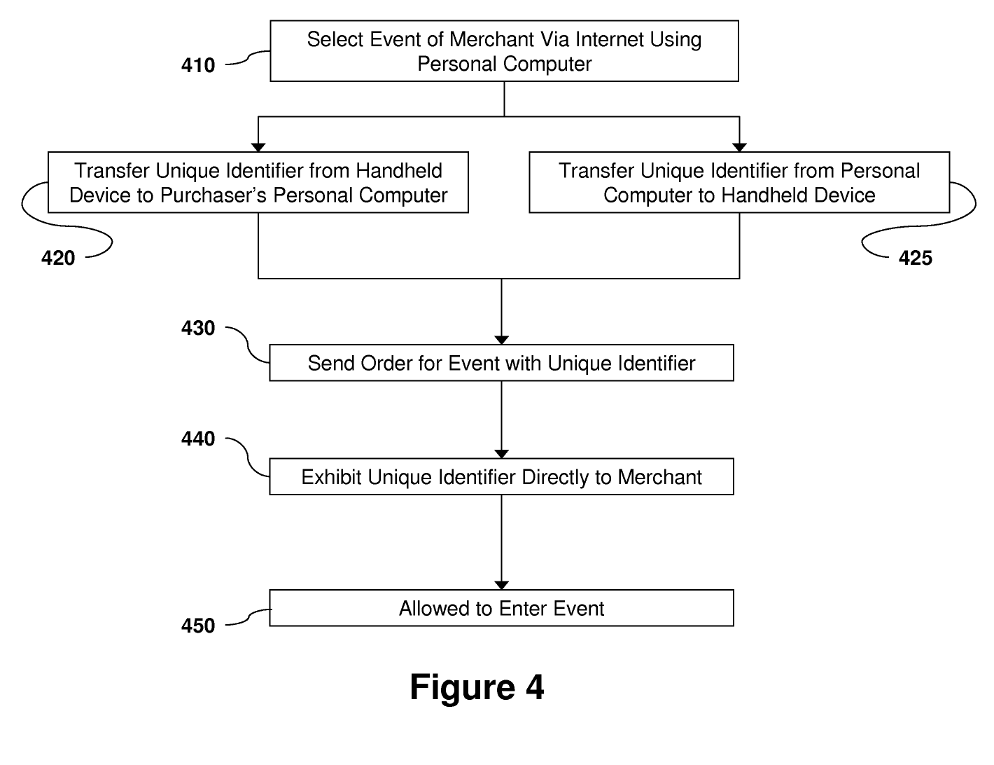

FIG. 4 shows methods of ordering tickets, utilizing devices of the disclosed technology. In step 410, an event of a merchant is selected via the internet (or another network allowing for ticket purchase). For example, a concert or sporting event may be selected. Then, depending on the embodiment, either step 420 or 425 may be carried out. It should also be understood that step 430 may come before steps 420 or 425.

In step 420, the unique identifier of a handheld device is transferred to a personal computer used to order the ticket. In such a case, the unique identifier has permanence on the handheld device, such as on device 110 shown in FIG. 1. Alternatively, when step 425 is carried out, the unique identifier is transferred from the personal computer to the handheld device. In such a case, a unique identifier having permanence on the personal computer is used. As noted above, such a unique identifier may be a MAC address, serial number, or the like. Still further, the unique identifier may be a transaction identifier assigned by the merchant. It may be human-readable or require computer aided interpretation or verification of correctness, in order to avoid user ability to modify the data and conduct a fraudulent transaction.

In step 430, a ticket for the event is ordered using conventional means (e.g., credit card payment) via the internet. With the order, the unique identifier is sent to the merchant in embodiments of the disclosed technology. It should be understood that where the merchant assigns the unique identifier, it is sent from the merchant to the purchaser, such as by way of using software to encode and/or encrypt the unique identifier, which is then transferred to the handheld device.

In step 440 which takes places, for example, at the event location, the handheld device functions as a “virtual ticket.” The purchaser can enter and/or leave the venue by exhibiting the unique identifier directly to the merchant, using any of the methods described above. For example, using near field communication, the handheld device may wirelessly communicate the unique identifier at an entry point to a stadium or to a device held by an attendant at an entrance and, in step 450, be granted entrance into the event (e.g., receive the service paid for). It should also be understood that the unique identifier or device which comprises the unique identifier, in embodiments of the disclosed technology may be given to a third party to pick up the order. In this manner, the third party would pick up the order on behalf of the purchaser.

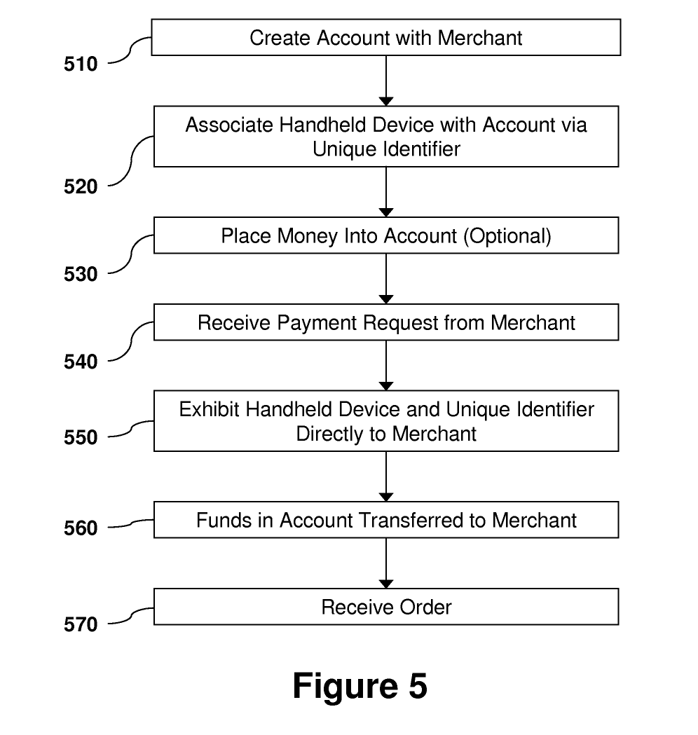

FIG. 5 shows a method of an embodiment of the disclosed technology where funds transfer takes place after direct exhibiting of the unique identifier. In step 510, an account is created with a merchant, for example, with a retailer, a credit card company, an online payment system, or the like. In step 520, a handheld device comprising a unique identifier is associated with the account and, optionally, in step 530, money is placed into the account for use with the disclosed technology. This may be accomplished, for example, by uploading a unique identifier of the device, such as a serial number, via a network connection or via direct communication to a device operated by the merchant. In this way, the device is “married” to the account and is used to carry out secure transactions. A cellular phone with an associated phone number, serial number of a memory chip in the phone, or the like, for example, can be used instead of a credit card and is thus more secure, requires the purchaser to carry one less item, and may securely, or by way of using encryption or changing data based on the unique identifier, transfer the unique identifier or version thereof to the merchant.

When a payment request is received in step 540, the unique identifier is exhibited to the merchant by way of any of the methods described above. The merchant receives the unique identifier, or an encrypted version thereof with data based on the unique identifier. The actual data sent may be modified based on the time and day, a pre-computed algorithm, be part of a Diffie-Hellman exchange or the like. Only once verification of the unique identifier is achieved, in the present embodiment, is step 560 carried out whereby funds in the account are transferred to the merchant. In step 570, the user receives his order of goods or services.

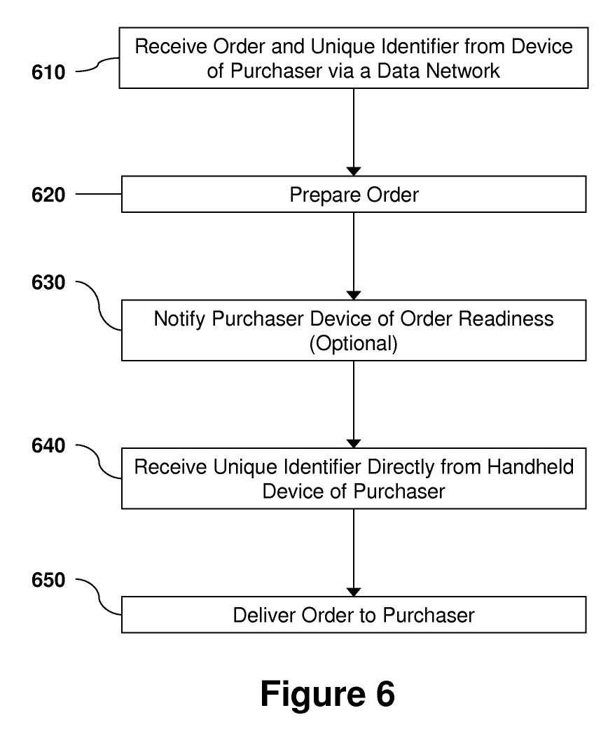

FIG. 6 shows the steps taken by a merchant in embodiments of the disclosed technology. In step 610, on a device such as the merchant order device 130 of FIG. 1, an order with a unique identifier is received from a device of a purchaser via a data network. For example, on the merchant's website, a purchaser may indicate which items or services are desired to be purchased, provide payment information, indicate whether the items or services should be delivered and to where, or will be picked up, and so forth. Payment may also be provided at the time of delivery or pickup. In step 620, the order is prepared which may comprise preparing a ticket, a food order, packaging and shipping, or the like. In optional step 630, the purchaser is notified by way of the device of the purchaser, such as purchasing device 110, that the order is ready for pickup or ready for delivery. Upon pickup or delivery, before the services or goods are actually delivered to the purchaser (in step 650), the purchaser must prove his identity or right to the ordered goods or services. This is accomplished in step 640, whereby the merchant receives the unique identifier directly from the handheld device of the purchaser, such as to the merchant delivery device 150.

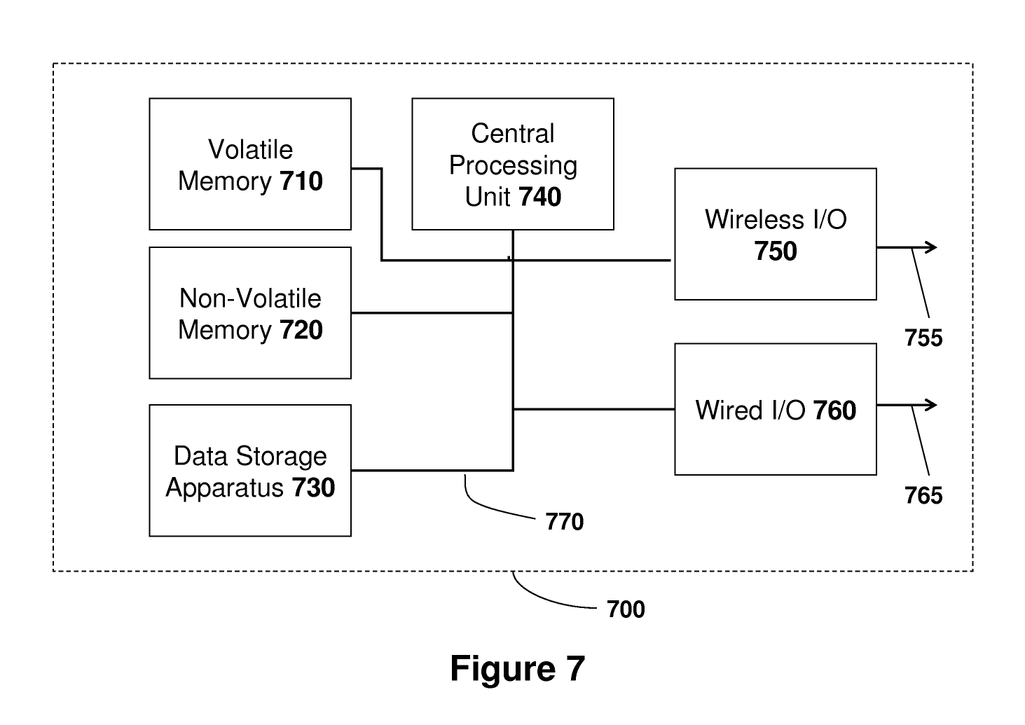

FIG. 7 shows a high level block diagram of a device on which embodiments of the disclosed technology may be carried out. The device may be a purchasing device 110, merchant order device 130, merchant delivery device 150, or merchant processing device 160. The device may comprise some or all of the high level elements shown in FIG. 6 and may comprise further devices or be part of a larger device.

Data bus 770 transports data between the numbered elements shown in device 700. Central processing unit 740 receives and processes instructions such as code. Volatile memory 710 and non-volatile memory 720 store data for processing by the central processing unit 740 and for permanent storage on the data storage apparatus 730, which may be a magnetic, optical, or other type of storage mechanism known in the art. Two input/output channels, such as a first wired input/output channel 750 and a second wireless input/output channel 760, communicate via communication channels 755 and 765 respectively. Channel 755 may be a near field communication (NFC) channel, wireless internet (e.g., 802.11), cellular channel, or the like. Channel 765 may be a connection such as a telephone connection, network cable, or the like. A unique identifier may be coded into a substantially unchangeable non-volatile memory 720, central processing unit 740, data storage apparatus 730, or elements of the wired or wireless input/outputs 750 and 760. A separate dedicated device for storing or managing the unique identifier may also be used in embodiments of the disclosed technology.

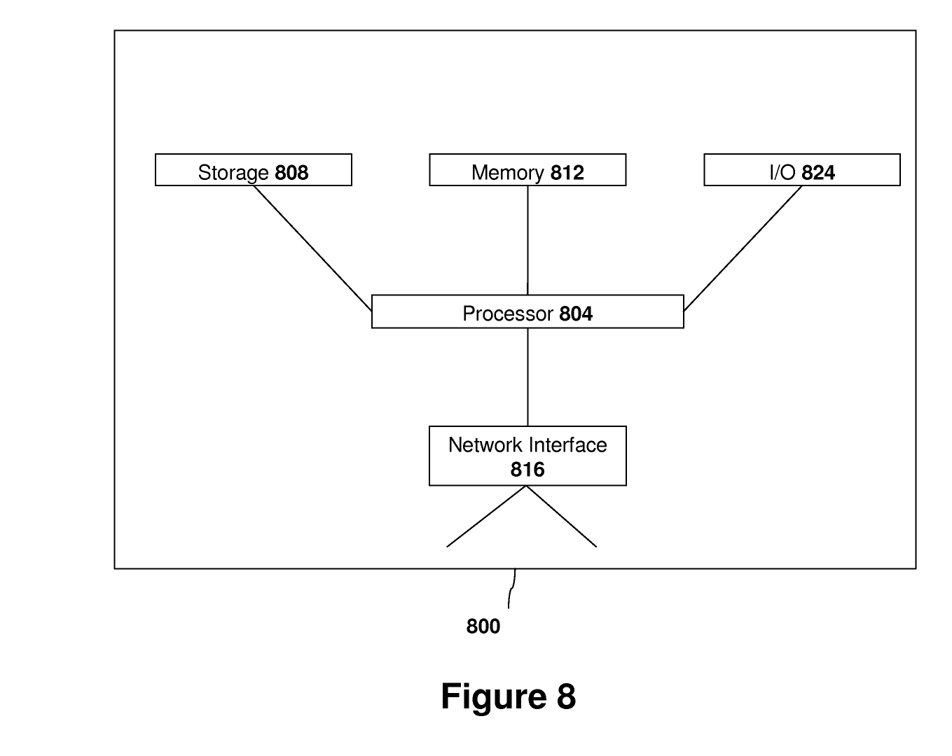

FIG. 8 shows a high-level block diagram of a computer that may be used to carry out the disclosed technology. Computer 800 contains a processor 804 that controls the overall operation of the computer by executing computer program instructions which define such operation. The computer program instructions may be stored in a storage device 808 (e.g., magnetic disk, database) and loaded into memory 812 when execution of the computer program instructions is desired. Thus, the computer operation will be defined by computer program instructions stored in memory 812 and/or storage 808, and the computer will be controlled by processor 804 executing the computer program instructions. Computer 800 also includes one or a plurality of input network interfaces for communicating with other devices via a network (e.g., the internet). Computer 800 also includes one or more output network interfaces 816 for communicating with other devices. Computer 800 also includes input/output 824, representing devices which allow for user interaction with the computer 800 (e.g., display, keyboard, mouse, speakers, buttons, etc.).

One skilled in the art will recognize that an implementation of an actual computer will contain other components as well, and that FIGS. 7 and 8 are high level representations of some of the components of a computer or switch and are for illustrative purposes. It should also be understood by one skilled in the art that the method and devices depicted or described in FIGS. 1 through 6 may be implemented on a device such as is shown in FIGS. 7 and 8.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the disclosed technology.

1. A method for delivering an order for goods or services, comprising the steps of:
receiving data via a public data network from a handheld wireless device, said data comprising an order for said item and at least part of a unique identifier;
at a time of said delivering, receiving directly from said handheld wireless device data comprising at least part of said unique identifier;
after verifying authenticity of said unique identifier, furnishing said order to said purchaser.

2. The method of claim 1, further comprising the step of delivering said order to a location of said handheld wireless device before said step of receiving data directly.

3. The method of claim 1, wherein said steps of receiving directly and furnishing are at a location where said order is prepared.

4. The method of claim 1, wherein said receiving directly comprises receiving directly to a handheld wireless device associated with a merchant furnishing said order.

5. The method of claim 1, wherein said unique identifier comprises a substantially unchangeable identifier of said handheld wireless device.

6. The method of claim 5, wherein said unique identifier further comprises an order identification number.

7. A method of placing an order for goods or services, comprising the steps of:
instructing a device to send an order for said item to a merchant via a public data network, wherein a unique identifier is further transmitted;
at a time of delivery, exhibiting data directly to said merchant, said data comprising said unique identifier;
after said merchant verifies authenticity of said unique identifier, receiving said goods or services.

8. The method of claim 7, wherein said exhibiting comprises displaying said unique identifier on said device.

9. The method of claim 7, wherein said exhibiting comprises a transfer of data via a short range wireless communication method.

10. The method of claim 7, wherein said instructing and said receiving occur at one location.

11. The method of claim 10, wherein said location is a seat within a venue.

12. The method of claim 9, wherein said exhibiting is to a handheld wireless device associated with a merchant furnishing said order.

13. The method of claim 7, wherein said unique identifier comprises a substantially unchangeable identifier of a device used in said method.

14. The method of claim 13, wherein said unique identifier further comprises an order identifier.

15. A device for processing an order comprising:
exhibiting means for exhibiting an order received over a data network, said order comprising a unique identifier of a handheld wireless device sending said order;
input means for receiving an input exhibited by said handheld wireless device;
verification means for verifying that said input comprises said unique identifier when delivery is underway; and
notification means for notifying when an order may be furnished based on said verification.

16. The device of claim 15, wherein said input means comprise near field communication.

17. The device of claim 15, wherein said device comprises a merchant order device and a merchant delivery device.

18. The device of claim 17, wherein said merchant delivery device is a handheld wireless device.

19. The device of claim 18, wherein said order is delivered to a location where said order was placed.

20. The device of claim 18, wherein said order is delivered to a location indicated by a recipient of said order.

21. The method of claim 7, wherein said instructing is carried out by a purchaser and said exhibiting is carried out by a third party.
